(19) United States
(12) Patent Application Publication
(10) Pub. No.: US 2014/0181632 A1
(43) Pub. Date: Jun. 26, 2014

(54) METHODS AND SYSTEMS FOR GENERATING A PORTAL THEME

(71) Applicant: XEROX CORPORATION, Norwalk, CT (US)

(72) Inventor: Zachary K. Mykins, Fairport, NY (US)

(73) Assignee: Xerox Corporation, Norwalk, CT (US)

(21) Appl. No.: 13/722,139

(22) Filed: Dec. 20, 2012

(51) Int. Cl. G06F 17/22

(52) U.S. Cl. CPC G06F 17/2247
USPC 715/234

(57) ABSTRACT

A system and method for generating a web portal theme. A content of an existing webpage can be analyzed and a webpage markup language (e.g., Hypertext Markup Language) source can be interrogated to gather information regarding appearance of the portal (e.g., images, fonts, colors, and Cascading Style Sheets) utilizing a toolbar associated with the webpage. A new page can be generated based on the information and the page can be presented to an administrator. The page can be modified based on the information and ranked based on usage. The page can also be customized and applied to the portal by the administrator.

### TECHNICAL FIELD

Embodiments are generally related to web scraping and web extraction/harvesting techniques and systems. Embodiments are also related to websites, such as web portals. Embodiments are additionally related to the generation of portal themes.

### BACKGROUND OF THE INVENTION

Web scraping (e.g., web harvesting or web data extraction) is a computer software technique of extracting information from websites. Usually, such software programs simulate human exploration of the World Wide Web by either implementing low-level Hypertext Transfer Protocol (HTTP), or embedding a fully-fledged web browser, such as Internet Explorer or Mozilla Firefox.

Web scraping is closely related to web indexing, which indexes information on the web using a bot and is a universal technique adopted by most search engines. In contrast, web scraping focuses more on the transformation of unstructured data on the web, typically in HTML format, into structured data that can be stored and analyzed in a central local database or spreadsheet. Web scraping is also related to web automation, which simulates human browsing using computer software. Uses of web scraping include online price comparison, weather data monitoring, website change detection, research, web mashup and web data integration.

Web portals are often the target of web scraping efforts. A web portal is a website that brings together information from diverse sources in a unified manner. Generally, each information source acquires its dedicated area on a page for displaying information (e.g., a portlet). Often a user can configure which information to display. Managed print service customer/account possess the ability to create the portal themed to match a company's brand. Several conventional approaches have been developed for generating the web portal theme. Such approaches, however, requires an inordinate amount of time for creating the portal theme and is difficult for users having limited HTML/CSS (Hypertext Markup Language/Cascading Style Sheet) knowledge.

Based on the foregoing, it is believed that a need exists for an improved approach for generating a web portal theme, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved web portal.

It is another aspect of the disclosed embodiments to provide for an improved method and system for generating a portal theme.

The aforementioned aspects and other objectives and advantages can now be achieved as described herein. Methods and systems for generating a web portal theme are disclosed herein. The content of an existing webpage can be analyzed and a webpage markup language (e.g., Hypertext Markup Language (HTML)) source can be interrogated to gather information regarding an appearance of the portal (e.g., images, fonts, colors, and Cascading Style Sheets) utilizing any number of methods such as, for example, a developer toolbar within a web browser for use in investigating an webpage. A new page can be generated based on the information and the new page presented to an administrator. The page can be modified based on the information and ranked based on usage. The page can also be customized and applied to the portal by the administrator.

An image can be identified if the image is over a specific size, included on multiple pages and/or having a file name that are identifiers such as “brand”, “logo”. A text can be identified by size and font styles. A style sheet can be identified by boarders, fonts, background colors and HTML element types and style. Such an approach automatically generates the portal theme with less amount of time.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a web portal theme generating module, an operating system, and a user interface, in accordance with the disclosed embodiments;

FIG. 3 illustrates a block diagram of a portal theme generating system, in accordance with the disclosed embodiments;

FIG. 4 illustrates a high level flow chart of operations illustrating logical operational steps of a method for generating a web portal theme, in accordance with the disclosed embodiments;

FIG. 5 illustrates a graphical user interface of a webpage, in accordance with the disclosed embodiments;

FIG. 6 illustrates a graphical user interface of a html text, in accordance with the disclosed embodiments;

FIG. 7 illustrates a graphical user interface of a new page, in accordance with the disclosed embodiments;

FIG. 8 illustrates a GUI that allows a user to change the auto generated new webpages logo, in accordance with the disclosed embodiments; and

FIGS. 9-10 illustrates a table of information in the context of a GUI that allows a user to change the auto generated new webpages style design, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

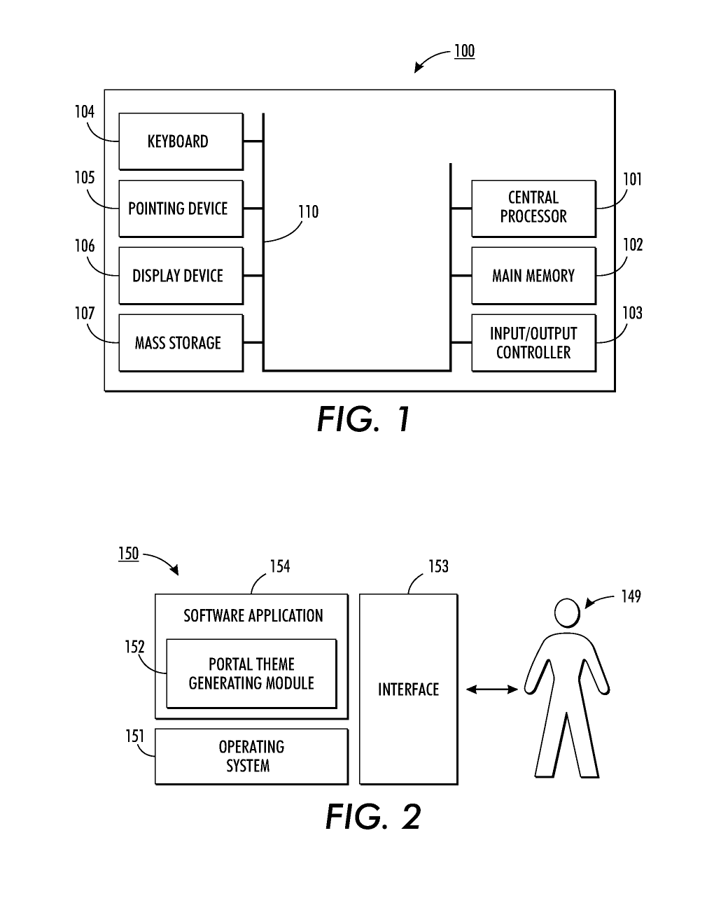

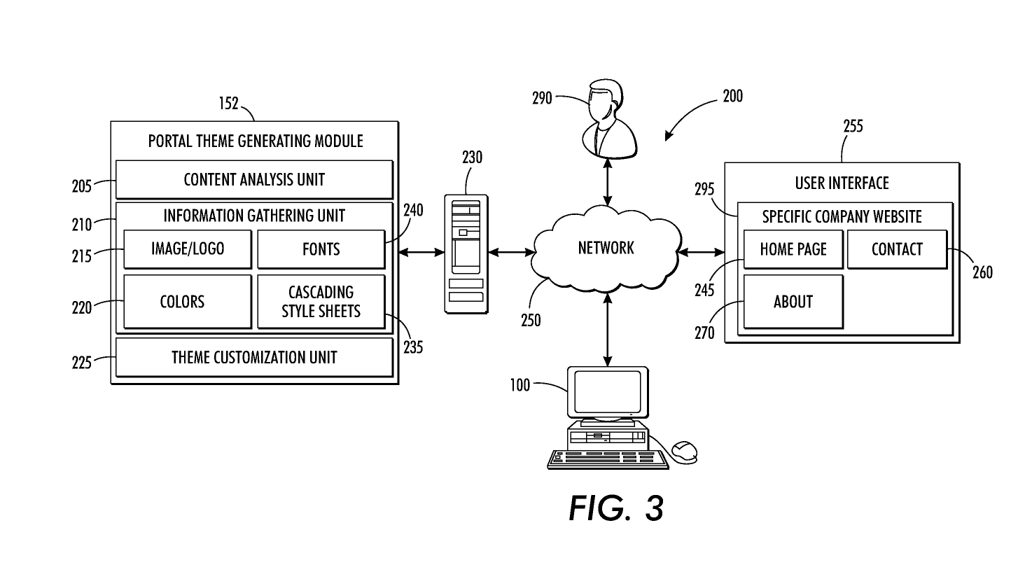

FIGS. 1-2 are provided as exemplary diagrams of data-processing environments in which embodiments may be implemented. It should be appreciated that FIGS. 1-2 are only exemplary and are not intended to assert or imply any limitation with regard to the environments in which aspects or embodiments of the disclosed embodiments can be implemented. Many modifications to the depicted environments may be made without departing from the spirit and scope of the disclosed embodiments.

As illustrated in FIG. 1, the disclosed embodiments can be implemented in the context of a data-processing system 100 that includes, for example, a system bus 110, a central processor 101, a main memory 102, an input/output controller 103, a keyboard 104, an input device 105 (e.g., a pointing device, such as a mouse, track ball, and pen device, etc.), a display device 106, a mass storage 107 (e.g., a hard disk), and an image capturing unit 108. In some embodiments, for example, a USB peripheral connection (not shown in FIG. 1) and/or other hardware components, may also be in electrical communication with the system bus 110 and components thereof. As illustrated, the various components of data-processing system 100 can communicate electronically through the system bus 110 or a similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

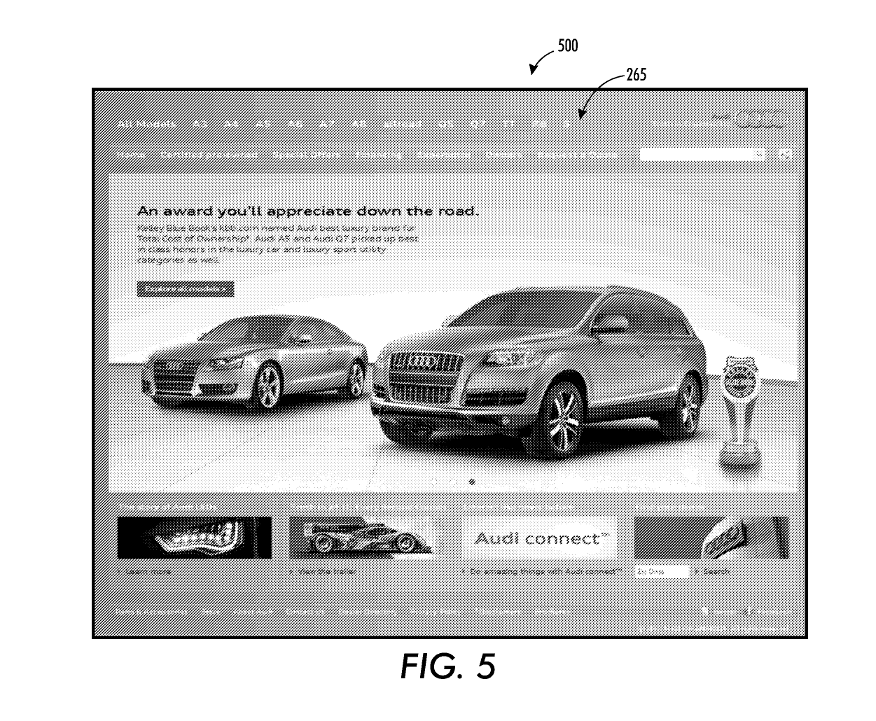

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 153. The software application 154 can include a web portal generating module 152 for generating a web portal. Software application 154, on the other hand, can include instructions, such as the various operations described herein with respect to the various components and modules described herein, such as, for example, the method 400 depicted in FIG. 4.

FIGS. 1-2 are thus intended as examples, and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

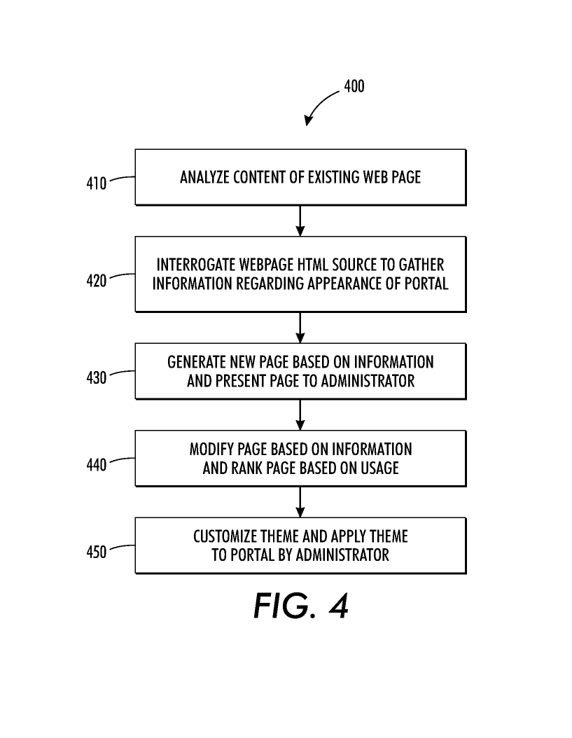

FIG. 3 illustrates a block diagram of a portal theme generating system 200, in accordance with the disclosed embodiments. Note that in FIGS. 1-10, identical or similar blocks are generally indicated by identical reference numerals. The portal theme generation system 200 includes a content analyzing server 230 configured with the portal theme generating module 152 for generating the web portal. The web portal can be employed to deliver complex and diverse content over a computer network. The portal can display content that can be obtained from sources external to a web server. The portal theme generating module 152 includes a content analyzing unit 205, an information gathering unit 210 and a theme customization unit 225 connected to a network 250.

Note that the network 250 may employ any network topology, transmission medium, or network protocol. The network 250 may include connections, such as wire, wireless communication links, or fiber optic cables. Network 250 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages.

The content analyzing unit 205 analyses a content of an existing webpage 295 for example, a home page 245, contact 260, about 270 displayed on a user interface 255. The content analyzing unit 205 can further interrogate the webpage 295 HTML source to gather information regarding the appearance of the portal. Note that the information can be for example, image/logo 215, fonts 240, colors 220, and Cascading Style Sheets (CSS) 235. The information gathering unit 210 generates a new page based on the information and the page can be presented to an administrator 290. The theme customization unit 225 modifies the page based on the information and rank the page based on usage. The theme customization unit 225 customizes the theme and applies the theme to the portal by the administrator 290.

FIG. 4 illustrates a high level flow chart of operations illustrating logical operational steps of a method 400 for generating the web portal theme, in accordance with the disclosed embodiments. It can be appreciated that the logical operational steps shown in FIG. 4 can be implemented or provided via, for example, a module such as module 154 shown in FIG. 2 and can be processed via a processor, such as, for example, the processor 101 shown in FIG. 1.

Initially as indicated at block 410, the content of the existing webpage 295 can be analyzed. The webpage HTML source can be interrogated to gather information regarding appearance of the portal (e.g., images, fonts, colors, and Cascading Style Sheets (CSS)), as shown at block 420. A new page can be generated based on the information and the page can be presented to the administrator 290, as illustrated at block 430. The page can be modified based on the information and ranked based on usage, as depicted at block 440. The theme can also be customized and applied to the portal by the administrator 290, as depicted at block 450.

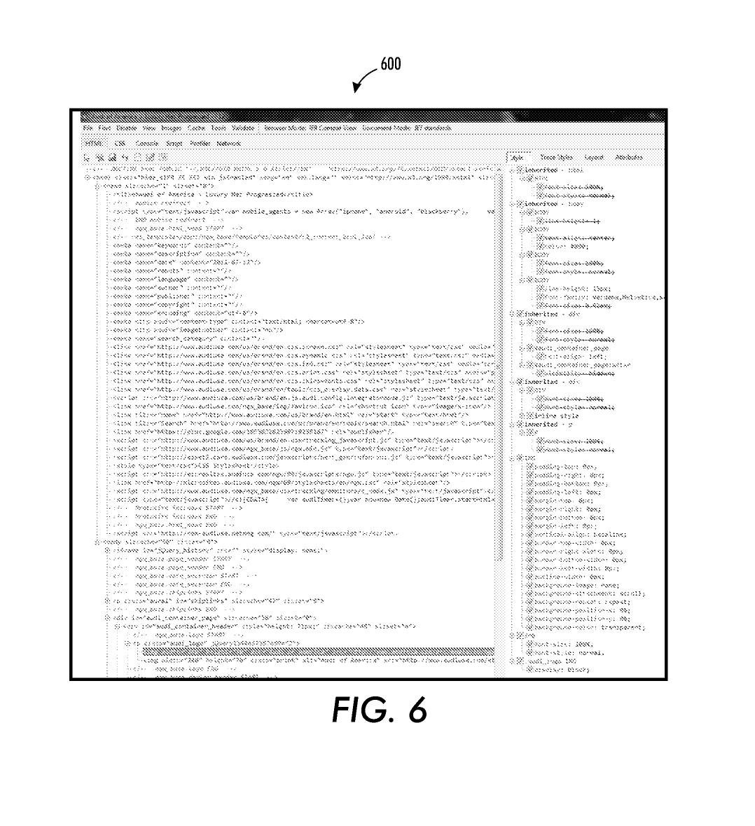

FIG. 5 illustrates a graphical user interface 500 of a company webpage, in accordance with the disclosed embodiments. The graphical user interface 500 includes the developer toolbar 265 to investigate the webpage HTML source to acquire some of the items that can be employed for the branding of a company.

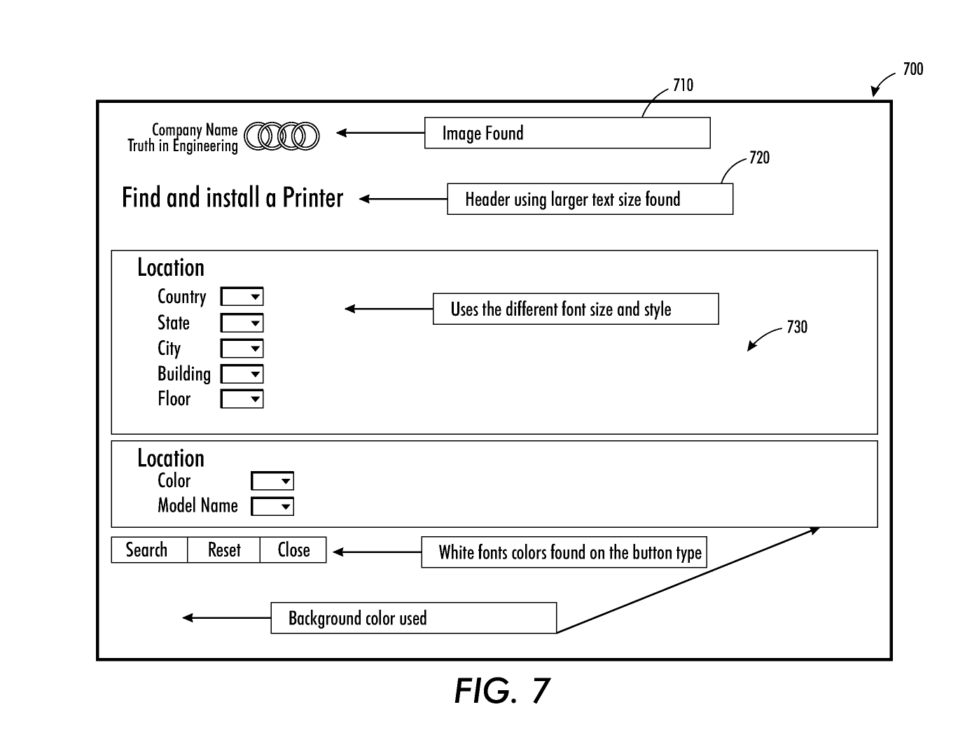

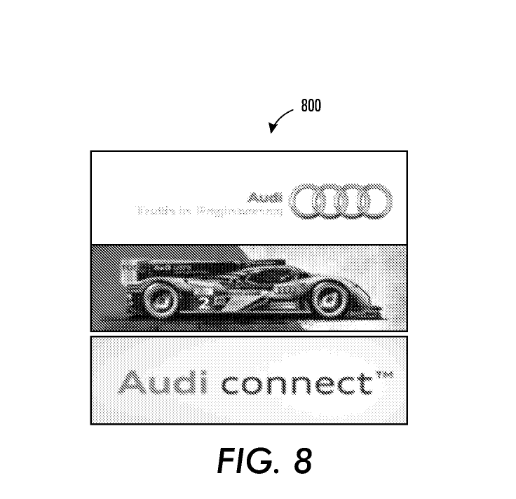

FIG. 6 illustrates a graphical user interface 600 of a html text, in accordance with the disclosed embodiments. FIG. 7 illustrates a graphical user interface of a new customer facing page 700, in accordance with the disclosed embodiments. An image 710 can be identified if the image is over a specific size, included on multiple pages and/or having a file name that are identifiers such as “brand”, “logo”. A text 720 can be identified by size and font styles. A style sheet 730 can be identified by boarders, fonts, background colors and HTML element types and style.

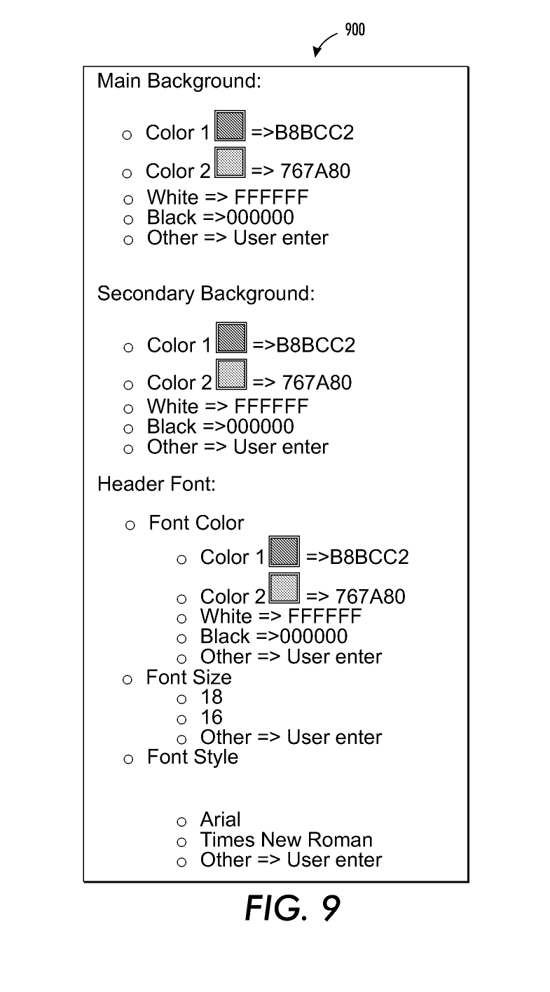

FIG. 8 illustrates a graphical user interface of a logo 700 customized from the webpage, in accordance with the disclosed embodiments. The GUI depicted in FIG. 8 allows a user to change the auto generated new webpages logo. The list of the logos are the images that the auto generator was able to extract from the original webpage based on, for example, over a specific size, included on multiple pages, and having a file name(s) that are identifiers such as “brand,” “logo,” etc.

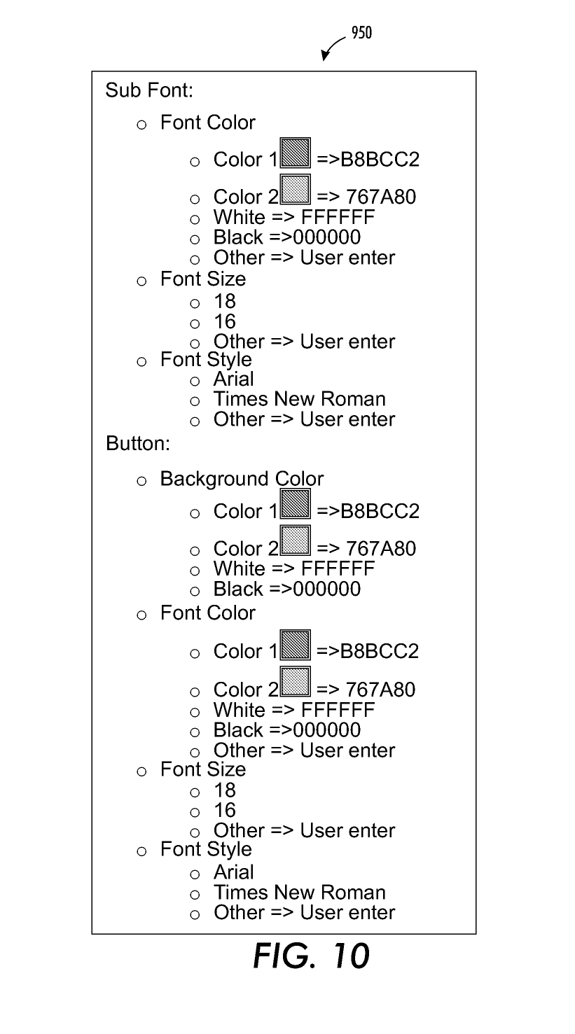

FIGS. 9-10 illustrate a table 800 and 850 of information gathered from the webpage to generate the customer facing page, in accordance with the disclosed embodiments. The information includes color for main background and a secondary background, font color, font size and font style for a header font, font color, font size and font style for a sub font, background color, font color, font size and font style for a button. The system 200 automatically generates the portal theme with less amount of time. The GUI depicted in FIGS. 9-10 allows a user to change the auto generated new webpages style design (e.g., font size, background, color, font color, etc). The list of the style elements constitutes the styles that the auto generator was able to extract from the original webpage

Based on the foregoing, it can be appreciated that various methods and systems can be implemented for analyzing the content an existing webpage of, for example, a Managed Print Service client, to determine a theme that can then be used by a web portal for matching a brand or other information. The investigation of existing pages permits this approach to be employed for gathering, for example, images, fonts, colors, CSS (Cascading Style Sheets) and so forth. Based on the findings, data can be presented to an administrator of the webpage. The portal designer would then be able to further customize the theme and apply the theme to their portal. Benefits of such an approach include much faster development time to deliver, for example, a customer-branded portal.

Based on the foregoing, it can also be appreciated that a number of embodiments, preferred and alternative, are disclosed herein. For example, in one embodiment, a method can be implemented for generating a portal theme. Such a method can include the steps or logical operations of analyzing an existing webpage for content and a webpage markup language source thereof in order to gather data regarding an appearance of a portal utilizing a toolbar associated with the existing webpage, generating and presenting a page based on the data in order to modify the page based on the data and rank the page based on a usage thereof, and customizing the page in order to thereafter apply the page to the portal.

In another embodiment, the markup language may constitute a hypertext markup language. In another embodiment, the step or logical operation of analyzing the existing webpage for content and the webpage markup language source, can further include step or logical operation of analyzing the existing webpage and the webpage markup language source utilizing a toolbar associated with the existing webpage. In some embodiments, the data can include information indicative of, for example, an image, a color, a font, a cascading style sheet, and so forth.

In still another embodiment, a system can be implemented for generating a portal theme. Such a system can include a processor; a data bus coupled to the processor; and a computer-usable medium embodying computer program code, the computer-usable medium being coupled to the data bus. The computer program code can include, for example, instructions executable by the processor and configured for analyzing an existing webpage for content and a webpage markup language source thereof in order to gather data regarding an appearance of a portal utilizing a toolbar associated with the existing webpage, generating and presenting a page based on the data in order to modify the page based on the data and rank the page based on a usage thereof, and customizing the page in order to thereafter apply the page to the portal.

In some embodiments, the aforementioned markup language can include, for example, a hypertext markup language. In another embodiment, the aforementioned instructions for analyzing the existing webpage for content and the webpage markup language source, can be further configured for analyzing the existing webpage and the webpage markup language source utilizing a toolbar associated with the existing webpage.

In still another embodiment, a processor-readable medium storing code representing instructions to cause a process for generating a portal, can be implemented. Such code can include code to, for example, analyze an existing webpage for content and a webpage markup language source thereof in order to gather data regarding an appearance of a portal utilizing a toolbar associated with the existing webpage; generate and presenting a page based on the data in order to modify the page based on the data and rank the page based on a usage thereof; and customize the page in order to thereafter apply the page to the portal.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for generating a portal theme, said method comprising:
analyzing an existing webpage for content and a webpage markup language source thereof in order to gather data regarding an appearance of a portal utilizing a toolbar associated with said existing webpage;
generating and presenting a page based on said data in order to modify said page based on said data and rank said page based on a usage thereof;
customizing said page in order to thereafter apply said page to said portal.

2. The method of claim 1 wherein said markup language comprises a hypertext markup language.

3. The method of claim 1 wherein analyzing said existing webpage for content and said webpage markup language source, further comprises analyzing said existing webpage and said webpage markup language source utilizing a toolbar associated with said existing webpage.

4. The method of claim 1 wherein said data comprises information indicative of an image.

5. The method of claim 1 wherein said data comprises information indicative of a font.

6. The method of claim 1 wherein said data comprises information indicative of a color.

7. The method of claim 1 wherein said data comprises information indicative of a cascading style sheet.

8. A system for generating a portal theme, said system comprising:
a processor;
a data bus coupled to said processor; and
a computer-usable medium embodying computer program code, said computer-usable medium being coupled to said data bus, said computer program code comprising instructions executable by said processor and configured for:
analyzing an existing webpage for content and a webpage markup language source thereof in order to gather data regarding an appearance of a portal utilizing a toolbar associated with said existing webpage;
generating and presenting a page based on said data in order to modify said page based on said data and rank said page based on a usage thereof;
customizing said page in order to thereafter apply said page to said portal.

9. The system of claim 8 wherein said markup language comprises a hypertext markup language.

10. The system of claim 8 wherein said instructions for analyzing said existing webpage for content and said webpage markup language source, are further configured for analyzing said existing webpage and said webpage markup language source utilizing a toolbar associated with said existing webpage.

11. The system of claim 8 wherein said data comprises information indicative of an image.

12. The system of claim 8 wherein said data comprises information indicative of a font.

13. The system of claim 8 wherein said data comprises information indicative of a color.

14. The system of claim 8 wherein said data comprises information indicative of a cascading style sheet.

15. A processor-readable medium storing code representing instructions to cause a process for generating a portal them, said code comprising code to:
analyze an existing webpage for content and a webpage markup language source thereof in order to gather data regarding an appearance of a portal utilizing a toolbar associated with said existing webpage;
generate and presenting a page based on said data in order to modify said page based on said data and rank said page based on a usage thereof; and
customize said page in order to thereafter apply said page to said portal.

16. The processor-readable medium of claim 15 wherein said markup language comprises a hypertext markup language.

17. The processor-readable medium of claim 15 wherein said code analyze said existing webpage for content and said webpage markup language source, further comprises code to analyze said existing webpage and said webpage markup language source utilizing a toolbar associated with said existing webpage.

18. The processor-readable medium of claim 15 wherein said data comprises information indicative of an image.

19. The processor-readable medium of claim 15 wherein said data comprises information indicative of a font.

20. The processor-readable medium of claim 15 wherein said data comprises at least one of the following: information indicative of a color or a cascading style sheet.
